(19) United States
(12) Patent Application Publication
(10) Pub. No.: US 2024/0030673 A1
(43) Pub. Date: Jan. 25, 2024

(54) MAGNETIC SWITCH WITH IMPEDANCE CONTROL FOR AN OPTICAL SYSTEM

(71) Applicant: Cymer, LLC, San Diego, CA (US)

(72) Inventors: Changqi You, San Diego, CA (US); Paul Christopher Melcher, El Cajon, CA (US); Yuda Wang, San Diego, CA (US)

(21) Appl. No.: 18/265,765

(22) PCT Filed: Dec. 9, 2021
(86) PCT No.: PCT/US2021/062704

§ 371 Date: Jun. 7, 2023

Related U.S. Application Data
(60) Provisional application No. 63/129,369, filed on Dec. 22, 2020.

(51) Int. Cl. H01S 3/091; H01S 3/23; H01S 3/225; H01S 3/094; H01F 27/24

(52) U.S. Cl. CPC H01S 3/0912; H01S 3/2308; H01S 3/225; H01S 3/094076; H01F 27/24; H01S 2302/00

(57) ABSTRACT

One or more properties of an electrical quantity are determined based on one or more operating characteristics of an optical system that includes a laser system; an impedance of a magnetic core of a magnetic switching network is adjusted by providing the electrical quantity to a coil that is magnetically coupled to the magnetic core; and after adjusting the impedance of the magnetic core, a pulse of light is produced. Producing the pulse of light includes: saturating the magnetic core such that an electrical pulse is provided to an excitation mechanism of the laser system.

### CROSS REFERENCE TO RELATED APPLICATIONS

This application claims priority to U.S. Application No. 63/129,369, filed Dec. 22, 2020, titled MAGNETIC SWITCH WITH IMPEDANCE CONTROL FOR AN OPTICAL SYSTEM, which is incorporated herein in its entirety by reference.

### TECHNICAL FIELD

This disclosure relates to a magnetic switch with impedance control for an optical system. The optical system may be or include, for example, an excimer laser and may produce deep ultraviolet (DUV) light.

### BACKGROUND

Photolithography is the process by which semiconductor circuitry is patterned on a substrate such as a silicon wafer. A photolithography optical source (or light source) provides the deep ultraviolet (DUV) light used to expose a photoresist on the wafer. One type of gas discharge light source used in photolithography is known as an excimer light source or laser. An excimer light source typically uses a combination of one or more noble gases, such as argon, krypton, or xenon, and a reactive such as fluorine or chlorine. The excimer light source derives its name from the fact that under the appropriate condition of electrical stimulation (energy supplied) and high pressure (of the gas mixture), a pseudo-molecule called an excimer is created, which only exists in an energized state and gives rise to amplified light in the ultraviolet range. An excimer light source produces a light beam that has a wavelength in the deep ultraviolet (DUV) range and this light beam is used to pattern semiconductor substrates (or wafers) in a photolithography apparatus. The excimer light source can be built using a single gas discharge chamber or using a plurality of gas discharge chambers.

### SUMMARY

In one aspect, a system includes: a first optical subsystem configured to produce a pulsed seed light beam, the first optical subsystem including: a first chamber configured to hold a first gaseous gain medium, and a first excitation mechanism in the first chamber; a second optical subsystem configured to produce a pulsed output light beam based on the pulsed seed light beam, the second optical subsystem including: a second chamber configured to hold a second gaseous gain medium, and a second excitation mechanism in the second chamber; a first magnetic switching network configured to activate the first excitation mechanism, where activating the first excitation mechanism causes the first optical subsystem to produce a pulse of the pulsed seed light beam; a second magnetic switching network configured to activate the second excitation mechanism, where activating the second excitation mechanism causes the second optical subsystem to produce a pulse of the pulsed output light beam; and a controller configured to: adjust an impedance of one or more magnetic cores in the first magnetic switching network based on a first indication, the first indication includes an indication of one or more operating characteristics of one or more of the first optical subsystem and the first magnetic switching network; and adjust an impedance of one or more magnetic cores in the second magnetic switching network based on a second indication, the second indication includes an indication of one or more operating characteristics of one or more of the second optical subsystem and the second magnetic switching network.

Implementations may include one or more of the following features.

The controller may be configured to adjust the impedance of the one or more magnetic cores in the first magnetic switching network before activating the first excitation mechanism, and the controller may be configured to adjust the impedance of the one or more saturated magnetic cores of the second magnetic switching network before activating the second excitation mechanism.

The first magnetic switching network may include: a first commutator module including a first saturable reactor and a first magnetic core, and a first compression module including a second saturable reactor and a second magnetic core; the second magnetic switching network may include: a second commutator module including a third saturable reactor and a third magnetic core, and a second compression module including a fourth saturable reactor and a fourth magnetic core; and the controller may be configured to: adjust the impedance of the first magnetic core and the second magnetic core based on the first indication of one or more operating characteristics; and adjust the impedance of the third magnetic core and the fourth magnetic core based on the second indication of one or more operating characteristics.

The controller may be configured to adjust the impedance of the one or more magnetic cores of the first magnetic switching network by providing electrical current to one or more coils, each of the one or more coils being magnetically coupled to one of the one or more magnetic cores of the first magnetic switching network, and one or more properties of the electrical current is based on the first indication. The controller may be configured to adjust the impedance of the one or more magnetic cores of the second magnetic switching network by providing electrical current to one or more coils, each of the one or more coils being magnetically coupled to one of the one or more magnetic cores of the second magnetic switching network, and one or more properties of the electrical current is based on the second indication. The one or more properties of the electrical current may include an amplitude of the electrical current.

The first optical chamber may include a pressurized gain medium and the first excitation mechanism may include two electrodes. The operating characteristics of the first optical chamber may include one or more of: a magnitude of a voltage pulse applied to at least one of the electrodes in the first optical chamber; a repetition rate of a pulsed light beam produced by the first optical chamber; and a pressure of the gain medium in the first optical chamber. The operating characteristics of the first magnetic switching network may include a temperature of one or more of the magnetic cores in the first magnetic switching network. The second optical chamber may include a pressurized gain medium and the second excitation mechanism may include two electrodes. The operating characteristics of the second optical chamber may include: one or more of: a magnitude of a voltage pulse applied to at least one of the electrodes in the second optical chamber; a repetition rate of a pulsed light beam produced by the second optical chamber; and a pressure of the gain medium in the second optical chamber. The operating characteristics of the second magnetic switching network may include a temperature of one or more of the magnetic cores of the first magnetic switching network.

The first optical subsystem may include a master oscillator, and the second optical subsystem may include a power amplifier.

The pulsed seed light beam and the pulsed output light beam may both include one or more wavelengths in the deep ultraviolet (DUV) range. The first gaseous gain medium may include argon fluoride (ArF), krypton fluoride (KrF), or xenon chloride (XeCl); and the second gaseous gain medium may include argon fluoride (ArF), krypton fluoride (KrF), or xenon chloride (XeCl).

The system may further include: a first monitoring module configured to measure the one or more operating characteristics of the first optical source and to provide the indication of the one or more operating characteristics of the first optical system to the controller; and a second monitoring module configured to measure the one or more operating characteristics of the second optical source and to provide the indication of the one or more operating characteristics of the second optical system to the controller.

In another aspect, a controller includes: a monitoring module configured to access one or more operating characteristics of an optical system, the optical system including an optical source and a magnetic switching network; and the controller also includes a command module configured to control a power supply to provide an electrical quantity to an electrical network that is magnetically coupled to the magnetic switching network. The magnetic switching network is configured to provide an excitation pulse to the optical source, the electrical quantity places a magnetic core of the magnetic switching network in a non-saturation or reverse saturation state, and one or more properties of the electrical quantity are based on the one or more operating characteristics of the optical system.

Implementations may include one or more of the following features.

The one or more operating characteristics of the optical system may include any of: a magnitude of an excitation voltage provided to the optical source, a repetition rate of the pulsed light beam produced by the optical source, a temperature of the magnetic core, and a pressure of a gaseous gain medium in the optical source. The one or more properties of the electrical quantity may include an amplitude and a temporal duration.

The electrical quantity may include a voltage or a current. The electrical quantity may include a direct current (DC) electrical current, and the amplitude of the DC electrical current may be based on the one or more operating characteristics of the optical system. The command module may be further configured to determine a command signal based on the one or more operating characteristics of the optical system, and to control the power supply based on the command signal. The one or more properties of the electrical quantity may include an amplitude and a temporal duration, the amplitude may have a value that depends on one or more of the operating characteristics, and the temporal duration may have a value that depends on one or more of the operating characteristics.

The controller may control the power supply after each pulse of a plurality of pulses in the pulsed light beam produced by the optical system such that the magnetic core of the magnetic switch is placed in the non-saturation or reverse saturation state after each of the plurality of pulses is produced. The plurality of pulses may be consecutive pulses in a burst of pulses. The plurality of pulses may include a first pulse in a first burst of pulses and a second pulse in a second burst of pulses. One property of the electrical quantity may have a first value to place the magnetic core in the non-saturation or reverse saturation state after a first one of the plurality of pulses and a second value to place the magnetic core in the non-saturation or reverse saturation state after a second one of the plurality of pulses, the first value different than the second value.

In another aspect, a method includes: determining one or properties of an electrical quantity based on one or more operating characteristics of an optical system that includes a laser system; adjusting an impedance of a magnetic core of a magnetic switching network by providing the electrical quantity to a coil that is magnetically coupled to the magnetic core; and after adjusting the impedance of the magnetic core, producing a pulse of light. Producing the pulse of light includes: saturating the magnetic core such that an electrical pulse is provided to an excitation mechanism of the laser system.

Implementations may include one or more of the following features.

The electrical quantity may include an electrical current, and the one or more properties of the electrical quantity may include a magnitude or a temporal duration.

The one or more operating characteristics may include one or more of a magnitude of an excitation voltage provided to the laser system, a repetition rate of a pulsed light beam produced by the laser system, a temperature of the magnetic core, and a pressure of a gaseous gain medium of the laser system.

Adjusting the impedance of the magnetic core may include adjusting the impedance of the magnetic core to a pre-determined level.

Adjusting the impedance of the magnetic core may include placing the magnetic core in a reverse saturation state.

Implementations of any of the techniques described above may include a system, a method, a process, a device, or an apparatus. The details of one or more implementations are set forth in the accompanying drawings and the description below. Other features will be apparent from the description and drawings, and from the claims.

### DRAWING DESCRIPTION

FIG. 1A is a block diagram of an example of a system.

FIG. 1B is a schematic of an example of a switching network.

FIG. 1C is an example of a magnetization curve.

FIG. 1D is an example of electrical current as a function of time.

FIG. 2 is a block diagram of an example of a two-stage laser system.

FIG. 3 is a block diagram of an example of a command module.

FIG. 4 is a schematic of another example of a switching network.

FIG. 5A is a block diagram of an example of a deep ultraviolet (DUV) optical system.

FIG. 5B is a block diagram of an example of a projection optical system that may be used in the DUV optical system of FIG. 5A.

FIG. 6 is a block diagram of another example of a DUV optical system.

FIGS. 7-10 show examples of experimental data.

### DETAILED DESCRIPTION

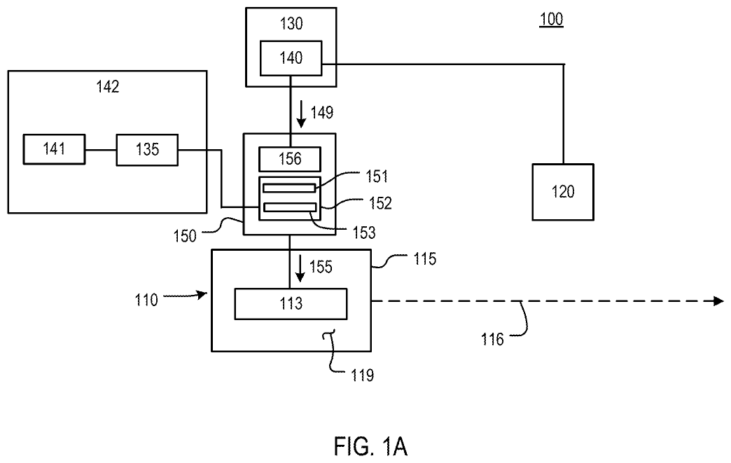

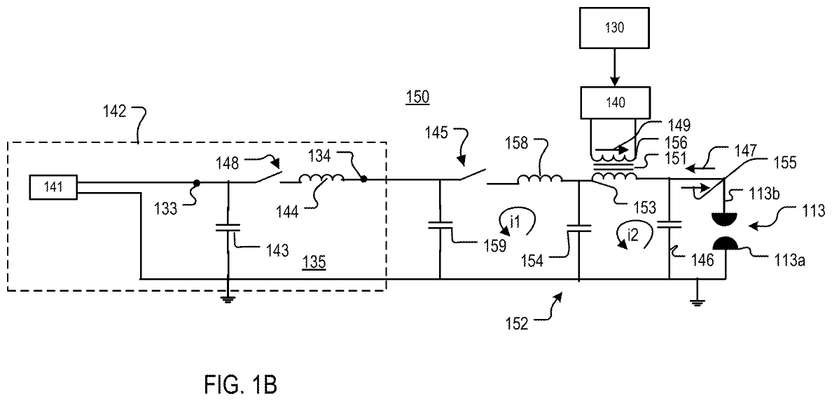

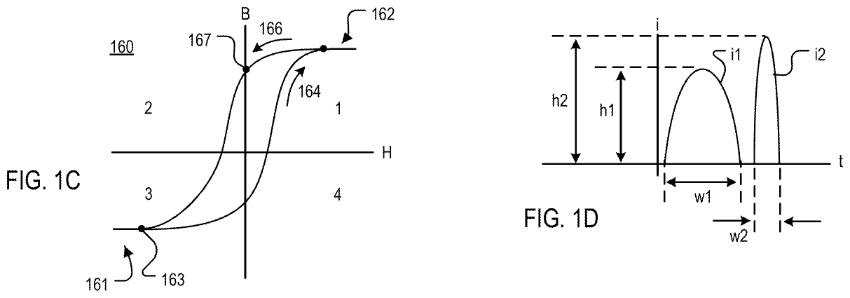

FIG. 1A is a block diagram of a system 100. The system 100 includes an optical source 110. The optical source 110 may be a deep ultraviolet (DUV) optical source that is used to expose semiconductor wafers. The optical source 110 includes a discharge chamber 115, which encloses a gain medium 119, and an excitation mechanism 113. The excitation mechanism 113 is activated by an electrical pulse 155 that is produced by a switching network 150. FIG. 1B is a schematic of the switching network 150. Activating the excitation mechanism 113 creates population inversion in the gain medium 119 and a pulse of light is produced. The switching network 150 generates a train of electrical pulses 155 that are provided to the excitation mechanism 113 such that the optical source 110 produces a pulsed light beam 116.

As discussed in more detail below, a command module 130 controls the impedance of a magnetic switch 153 in the switching network 150 using an electrical quantity 149. One or more properties of the electrical quantity 149 are based on one or more operating characteristics of the system 100. The operating characteristics of the system 100 include the operating characteristics of the optical source 110, the switching network 150, a power source 142 and/or operating characteristics of any component or subsystem of the optical source 110, the switching network 150, and the power source 142. In this way, the command module 130 is able to reset the impedance of the magnetic switch 153 to a constant value and/or adjust the impedance of the magnetic switch 153 such that the magnetic switch 153 has an operating point in a particular operating range prior to the production of an electrical pulse 155 (and thus prior to production of a pulse of the light beam 116) regardless of changes in the operating characteristics. The impedance of the magnetic switch 153 may be adjusted prior to producing each pulse in the light beam 116, or prior to producing one or more but not all pulses in the light beam 116.

The switching network 150 includes a pulse-generating network 152 and an electrical network 156. The magnetic switch 153 includes a magnetic core 151. The electrical network 156 is magnetically coupled to the magnetic switch 153 via the magnetic core 151. In the example shown in FIG. 1B, the electrical network 156 is a coil (for example, a coiled electrical wire) that is wrapped around the magnetic core 151. The magnetic switch 153 also may include an electrically conductive coil wrapped around the magnetic core 151. The magnetic switch 153 may be, for example, a saturable inductor.

The magnetic core 151 is any material that becomes magnetized in response to being exposed to an external magnetic field. The magnetic core 151 may be a magnetic material with a relatively high permeability, such as, for example, a ferromagnetic material such as iron or an iron alloy. Permeability (μ) is a measure of the degree of magnetization that the material obtains in response to an applied magnetic field. Although a ferromagnetic material is given as an example, other materials may be used.

FIG. 1C is an illustration of an example of a magnetization curve 160 of a material that may be used for the magnetic core 151. The magnetization curve in FIG. 1C is a plot of magnetization (B) of the magnetic core 151 as a function of magnetic field strength (H). The units of magnetization (B) are Teslas (T), and the units of the magnetic field strength (H) are amperes per meter (A/m). The magnetization curve 160 is non-linear and the magnetic core 151 experiences magnetic hysteresis. When a magnetic field having a first direction is applied to the magnetic core 151, the atomic dipoles in the material of the core 151 align with the first direction and the material of the core 151 becomes magnetized in a first direction. When the first magnetic field is removed, some of the alignment is retained. Thus, even when there is no external magnetic field (that is, when H=0), the magnetic material of the core 151 retains some magnetization.

The magnetic core 151 has a forward saturation region 162 and a reverse saturation region 161. The magnetic core 151 is saturated when the application of the external magnetic field no longer produces a further change in the magnetization of the material of the magnetic core 151. The impedance of the magnetic core 151 is lowest in the regions 162 and 161. When the magnetic core 151 is not saturated and the magnetization (B) is between the regions 161 and 162, the magnetic switch 153 has a relatively high impedance. For discussion purposes, the magnetization (B) of the magnetic core 151 is initially at an operating point labeled 163 in FIG. 1C. The operating point 163 is in the reverse saturation region 161. In other configurations, the operating point may start in a non-saturated region, outside of the forward saturation region 162.

The pulse-generating network 152 is electrically connected to a power source 142. Referring also to FIG. 1B, the power source 142 includes a high-voltage power supply 141 and a resonant charging circuit 135. The resonant charging circuit 135 is electrically connected to an output 133 node of the high-voltage power supply 141. The high-voltage power supply 141 may be, for example, a 32 kiloWatt (kW) power supply capable of supplying 900 V DC at the output node 133. The high-voltage power supply 141 may have other specifications and characteristics. For example, the power supply 141 may be a 52 kW power supply capable of supplying 800 V DC at the output node 133. The power supply 141 may be configured to provide other power and voltage amounts, and the above values of voltage and power are provided as examples. Moreover, the voltage at the output node 133 may be positive or negative relative to ground. In other words, in the example of the 32 kW power supply capable of supplying 900 V DC, the voltage at the output node 133 may be +900V or −900V. In the example discussed below, the power supply 141 has a negative polarity.

The resonant charging circuit 135 includes a capacitor 143, a switch 148, and an inductor 144. The switch 148 may be, for example, a transistor such as an insulated gate bipolar transistor (IGBT). The capacitor 143 is electrically connected to the output node 133 and ground. The switch 148 is electrically connected to the output node 133, and the switch 148 is in series with the inductor 144. When the switch 148 is closed, the inductor 144 is electrically connected to the capacitor 143. The resonant charging circuit 135 shown in FIG. 1B is an example. In other implementations, the resonant charging circuit 135 may include additional components such as, for example, diodes and additional switches.

The high-voltage power supply 141 applies a voltage across the capacitor 143. Electrical charge accumulates in the capacitor 143, and the voltage across the capacitor 143 increases or remains constant until the switch 148 closes. When the switch 148 closes, the electrical charge stored in the capacitor 143 is discharged and flows to a capacitor 159, which is electrically connected to an output node 134 of the resonant charging circuit 135. The switch 148 may be triggered to close after the voltage across the capacitor 143 reaches a specified voltage and/or after a specified time. The specified voltage value may be a commanded voltage, pre-set voltage value, or other voltage value. After the switch 148 closes, the charge on the capacitor 143 is discharged.

The electrical charge from the capacitor 143 accumulates in the capacitor 159, and the voltage across the capacitor 159 increases to the commanded voltage and remains at the commanded voltage until a switch 145 closes. When the switch 145 closes, the electrical charge stored in the capacitor 159 flows as electrical current (i1) in a resonant circuit formed by the capacitor 159, an inductor 158, and a capacitor 154. FIG. 1D shows an example of the current (i1) and a current (i2) as a function of time. The electrical current (i1) has a temporal width (w1), and an amplitude h1. The electrical current (i2) has a temporal width (w2) and an amplitude h2. The temporal width w1 is determined by the relative impedance values of the inductor 158, the capacitor 159, and the capacitor 154. For example, the temporal width w1 of the current (i1) and may be about 5 microseconds (μs). The temporal width w2 is determined by the relative impedance values of the capacitor 154, the magnetic switch 153, and the peaking capacitor 146. The temporal with w2 may be, for example 500 nanoseconds (ns).

The current (i1) flows out of the capacitor 154, and the absolute value of the voltage across the capacitor 154 increases. Although most of the current i1 flows out of the capacitor 154, leakage current also flows in the magnetic switch 153. The current that flows in the magnetic switch 153 is shown as the current i2 in FIG. 1D. The leakage current causes the magnetization of the core 151 to increase along a path 164 (FIG. 1C) from the operating point 163, and the core 151 is no longer in the reverse saturation region 161. The leakage current continues to flow into the magnetic switch 153, and the magnetization of the core 151 continues to increase along the path 164 until reaching the forward saturation region 162. When in the forward saturation region 162, the impedance of the core 151 is nearly zero. At this point, the magnetic switch 153 has a lower impedance than the inductor 158. The electrical energy stored in the capacitor 154 flows through the magnetic switch 153 as current (shown as i2 in FIG. 1D) and accumulates in a peaking capacitor 146. This forms a potential difference across the peaking capacitor 146. The absolute value of the voltage on the peaking capacitor 146 may be, for example, about 20 kV. The capacitor 146 is in parallel with the electrodes 113a and 113b. Thus, the potential difference across the capacitor 146 is also formed between the electrodes 113a and 113b. This potential difference across the electrodes 113a and 113b is the excitation pulse 155 that excites the gain medium 119 and the discharge chamber 115 emits an optical pulse.

The impedance of the magnetic switch 153 remains small until the current i2 is lower than a threshold current value that is determined by the coercivity (H_{c}) of the material of the magnetic switch 153. When the current i2 has passed through the magnetic switch 153, the current i2 no longer applies a magnetic field to the core 151 and the operating point moves to an operating point 167.

Although most of the energy in the electrical pulse 155 is absorbed by the excitation mechanism 113 and the gain medium 119, some of the energy in the electrical pulse 155 reflects back into the pulse-generating network 152 as reflected electrical current 147 (referred to as the reflection 147). In this example, the reflection 147 is in the same direction as the currents (i1) and (i2). Referring again to FIG. 1C, in this example, the magnetization (B) of the core 151 changes as a result of the reflection 147 and the operating point of the core 151 again moves toward the saturation region 162.

The magnitude of the reflection 147 depends on the operating characteristics. The operating characteristics may be quantities that are observed or measured and/or specifications or settings that are accessed from the optical source 110, the power source 142, the switching network 150, and/or other aspects of the system 100. The operating characteristics include any type of parameter or characteristic associated with the operation the discharge chamber 115, the gain medium 119, the excitation mechanism 113, and the switching network 150. The operating characteristics include, for example, the pressure of the gain medium 119, the magnitude and/or duration of the electrical pulse 155 applied to the excitation mechanism 113, the temperature of the gain medium 119, the temperature of the core 151, the temperature of components of the magnetic switch 153 other than the core 151, the specified voltage for the capacitor 143, the specified voltage for the capacitor 159, and/or the frequency at which the electrical pulse 155 is applied to the excitation mechanism 113 (which is related to the repetition rate of the light beam 116).

The operating characteristics vary during operation and use of the optical source 110 and may vary on a burst-to-burst or pulse-to-pulse basis. Thus, the amount that the magnetization (B) of the core 151 changes due to the reflection 147 is not constant and may be different for each pulse produced by the optical source 110. Accordingly, the amount of magnetic field (H) and the amount of time required to place the magnetic core 151 in the forward saturation region 162 such that the next electrical pulse 155 (and thus the next pulse of the light beam 116) are produced as expected are not necessarily constant during operation of the optical source 110.

To ensure a predictable magnetization of the core 151 at the beginning of an optical pulse generation cycle, the magnetic core 151 is biased using the electrical quantity 149 (for example, a bias current 149), and one or more properties of the electrical quantity 149 are based on the operating conditions.

The electrical network 156 is electrically connected to a bias power supply 140, which is controlled by the command module 130. The command module 130 receives or accesses data from a monitoring module 120, which accesses and/or monitors one or more operating characteristics. In the example shown in FIG. 1B, the electrical quantity 149 is a bias current that flows in the coil of the network 156. Returning to the example of FIG. 1C, the electrical quantity 149 moves the operating point of the core 151 toward the point 163 (and closer to the reverse saturation region 161). In some implementations, the electrical quantity 149 is such that the operating point is moved into the reverse saturation region 161 after each pulse of light is produced. In other words, the electrical quantity 149 resets the operating point of the magnetic core 151 (and thus the impedance of the core 151) to a known value or a predictable value (for example, an operating point in the reverse saturation region 161).

The command module 130 controls the bias power supply 140 and causes the bias power supply 140 to provide an output (for example, a voltage or current) to the electrical network 156. The properties (for example, magnitude) of the output are based on one or more of the operating characteristics such that the electrical quantity 149 is also based on the one or more of the operating characteristics. For example, the command module 130 may store a database or lookup table that relates one or more operating characteristics of the optical source 110 to one or more properties of the output of the bias power supply 140. Thus, the electrical quantity 149 is able to change to account for changes in the operating characteristics of the optical source 110. By controlling the bias power supply 140 in this manner, the magnetization of the magnetic core 151 is reset to a constant or nearly constant value prior to generating a pulse of the light beam 116 regardless of the values of the operating characteristics.

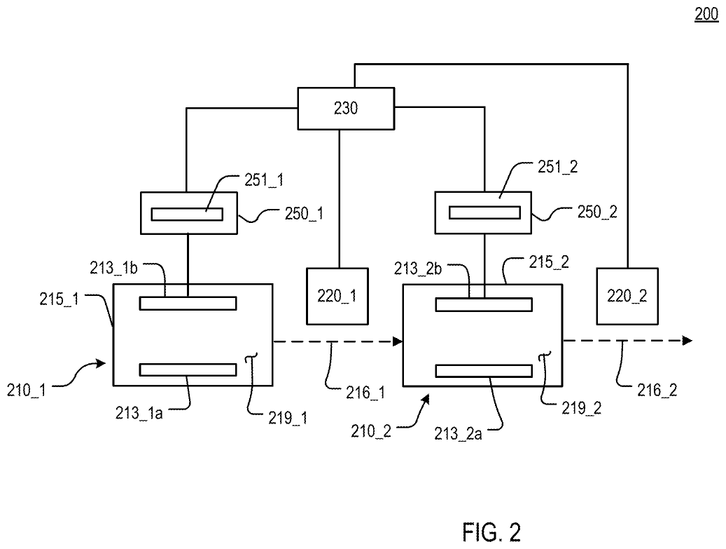

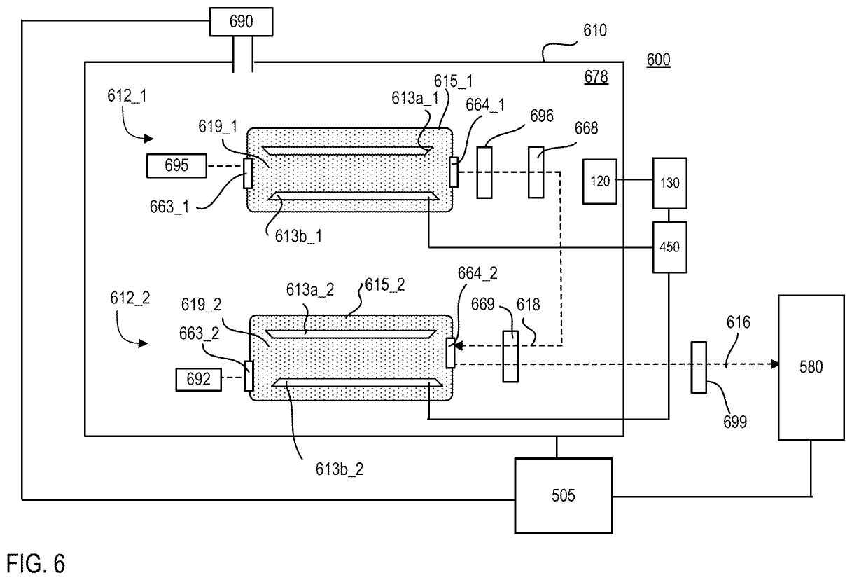

Resetting the magnetization of the magnetic core 151 to a known value and/or to a constant value at the beginning of the pulse generation cycle allows the timing of the electrical pulse 155 to be more finely and accurately controlled and predicted. For example, because the magnetization of the magnetic core 151 is always at the same operating point at the beginning of a pulse generation cycle, for a particular amount of electrical energy input into the magnetic switch, the magnetic core 151 will always reach the forward saturation region 162 in the same amount of time. The refined control of the timing of the production of the electrical pulse 155 (which excites the gain medium 119) allows the switching network 150 to be more effectively used, for example, when the optical source 110 is a multi-stage light source (such as shown in FIGS. 2 and 6). Moreover, the electrical quantity 149 may be controlled such that the magnetization of the magnetic core 151 is placed in the reverse saturation region 161 at the beginning of each pulse generation cycle. By controlling one or more properties of the electrical quantity 149 (and thereby controlling the magnetization of the magnetic core 151), the full magnetization range of the magnetic core 151 between the reverse saturation region 161 and the forward saturation region 162 may be utilized.

Furthermore, controlling the magnetization of the core 151 also improves the burst mode performance of the optical source 110. When operating in burst mode, the light beam 116 produced by the optical source 110 includes bursts of pulses of light separated by periods of time that do not include light pulses. Each burst may include, hundreds, thousands, tens of thousands, or more pulses. The pulses within a burst of pulses have a repetition rate that suits the application. For example, the pulses within a burst may have a repetition rate of 6,000 Hertz (Hz) or greater. The period between the bursts has a temporal duration that is much longer than the time between two consecutive pulses in a burst. For example, the time between the end of one burst of pulses and the next burst of pulses may be hundreds or thousands of times longer than the time between two consecutive pulses within the burst. At the beginning of a burst, transient effects within the discharge chamber 115 cause the amount of optical energy in the first few pulses (for example, the first 100 or 200 pulses) to vary dramatically. Additionally, in a multi-stage system, the timing differences between the various stages tend to be more significant at the beginning of the burst. Moreover, the transient varies based on operating characteristics such as, for example, voltage applied to the excitation mechanism 113, repetition rate, and the pressure of the gain medium 119. By controlling the magnetization of the core 151, the burst transient effects may be reduced.

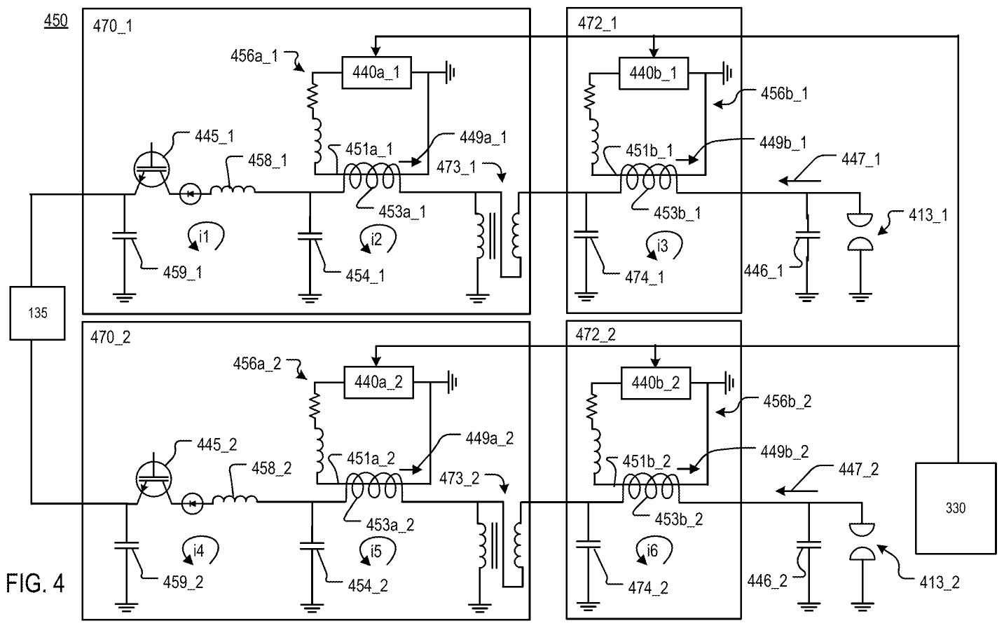

The schematic shown in FIG. 1B is provided as an example, and other implementations are possible. For example, the pulse-generating network 152 includes only one magnetic switch; and the resonant circuit formed by the capacitor 154, the magnetic switch 153, and the peaking capacitor 146 is a single magnetic compression stage. However, in other implementations, the pulse-generating network 152 includes additional magnetic compression stages. For example, the pulse-generating network 152 may include more than one magnetic switch and more than one magnetic compression stage. These additional stages are placed in the pulse-generation circuit such that the peaking capacitor 146 remains in parallel with the electrodes 113a and 113b. FIG. 4 shows an example of a switching network 450 that includes more than one magnetic compression stage.

Moreover, any variation of a multi-stage magnetic compression circuit may be used. For example, other implementations of the pulse-generation network 152 may include a separate bias power supply 140 and electrical network 156 for each magnetic compression stage, or one instance of the bias power supply 140 and electrical network 156 may be used to control the impedance of more than one magnetic switch. Further, the various components of the magnetic compression stages (for example, values of capacitor and inductance components) may be selected such that the current and voltage pulse produced at the peaking capacitor 146 has a shorter duration and larger amplitude than the voltage and current produced in the other stages.

Further, the pulse-generation network 152 may include other components such as, for example, diodes and one or more voltage transformers. Regardless of the specific configuration of the pulse-generation network 152, the impedance or magnetization of at least one of the magnetic switches in the pulse-generating network 152 is controlled with an electrical quantity such as the electrical quantity 149 as discussed above.

Additionally, in the example shown in FIG. 1B, the high-voltage power supply 141 provides a voltage having a negative polarity such that the voltage at the output node 133 is negative relative to ground. However, in other implementations, the high-voltage power supply 141 provides a voltage having positive polarity such that the voltage at the output node 133 is positive relative to ground. In implementations in which the polarity of the high-voltage power supply 141 is positive, the currents (i1) and (i2), and the reflection 147 flow in the opposite direction than what is shown in FIG. 1B.

FIG. 2 is a block diagram of a system 200. The system 200 includes a two-stage laser system 210. The two-stage laser system 210 includes a first discharge chamber 215_1, which produces a pulsed seed light beam 216_1, and a second discharge chamber 215_2, which amplifies the pulsed seed light beam 216_1 to produce an amplified pulse light beam 216_2. The first discharge chamber 215_1 encloses electrodes 213_1a and 213_1b and a gaseous gain medium 219_1, and the second discharge chamber 215_2 encloses electrodes 213_2a and 213_2b and a gaseous gain medium 219_2.

The system 200 also includes switching networks 250_1 and 250_2, each of which is an instance of the switching network 150 (FIG. 1A). The switching networks 250_1 and 250_2 include respective magnetic cores 251_1 and 251_2. The first discharge chamber 215_1 is monitored by a first monitoring module 220_1, and the second discharge chamber 215_2 is monitored by a second monitoring module 220_2. The monitoring modules 220_1 and 220_2 access or monitor one or more operating characteristics of the respective discharge chambers 215_1 and 215_2 and provide data about the operating characteristics to the command module 230. For example, the monitoring module 220_1 may measure the repetition rate of the seed light beam 216_1, and the monitoring module 220_2 may measure the repetition rate of the output light beam 216_2. In another example, the monitoring module 220_1 may be configured to communicate with an environmental sensor that measures the pressure and temperature of the gain medium 219_1. Similarly, the monitoring module 220_2 may be configured to communicate with an environmental sensor that measures the pressure and temperature of the gain medium 219_2. The command module 230 controls the impedance of the magnetic cores 251_1 and 251_2 based on the operating characteristics of the discharge chambers 215_1 and 215_2, respectively.

Additionally or alternatively, the monitoring modules 220_1 and 220_2 may be configured to monitor or access one or more operating characteristics related to other aspects of the system 200. For example, the monitoring module 220_1 may be configured to communicate with a temperature sensor in the switching network 250_1 to obtain a temperature of the magnetic core 251_1. The monitoring module 220_2 may be configured to communicate with a temperature sensor in the switching network 250_2 to obtain a temperature of the magnetic core 251_2. The monitoring modules 220_1 and 220_2 provide the data to the command module 230, and the command module controls the impedance of the magnetic cores 251_1 and 251_2 based on the data from the monitoring modules 220_1 and 220_2, respectively.

The pulse of the seed light beam 216_1 enters the discharge chamber 215_2. The electrical pulse 255_2 is provided to the electrode 213_2b and a potential difference is formed between the electrode 213_2b and the electrode 213_2a. The potential difference excites atoms, ions, and/or molecules in the gain medium 219_2. The atoms, ions, and/or molecules in the excited state may be stimulated by the pulse of the seed light beam 216_1 to emit more light into the same radiation modes to form an amplified light beam. Thus, the discharge chamber 215_2 amplifies the seed light beam 216_1 and emits the amplified light beam 216_2.

However, if a pulse of the seed light beam 216_1 passes through the discharge chamber 215_2 when the gain medium 219_2 is not excited, the pulse will not be amplified. The command module 230 controls the magnetic core 251_2 in the switching network 250_2 based on the operating characteristics of the discharge chamber 215_2 and/or the switching network 250_1 such that the gain medium 219_2 is excited when the seed light beam 216_1 passes through the discharge chamber 215_2. Moreover, the command module 230 also may control the magnetic core 251_1 in the switching network 250_1. For example, the command module 230 may cause the magnetic cores 251_1 and 251_2 in the respective switching networks 250_1 and 250_2 to reset to a constant level such that the time required to saturate the cores is constant and predictable.

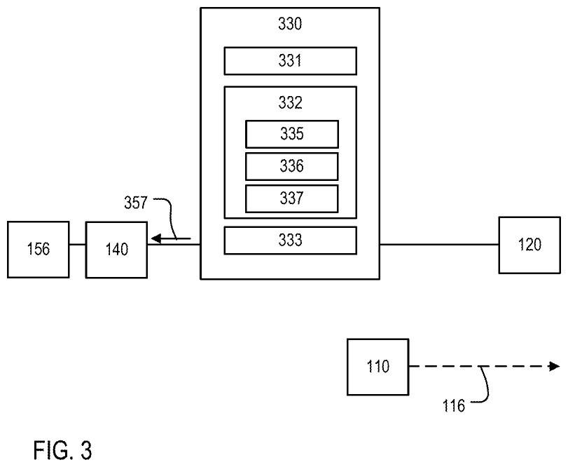

FIG. 3 is a block diagram of a command module 330. The command module 330 may be used as the command module 130 (FIG. 1A) or the command module 230 (FIG. 2). The command module 330 includes an electronic processing module 331, an electronic storage module 332, and an input/output (I/O) interface 333.

The electronic processing module 331 includes one or more processors suitable for the execution of a computer program such as a general or special purpose microprocessor, and any one or more processors of any kind of digital computer. Generally, an electronic processor receives instructions and data from a read-only memory, a random access memory (RAM), or both. The electronic processing module 331 may include any type of electronic processor. The electronic processor or processors of the electronic processing module 331 execute instructions and access data stored on the electronic storage 332. The electronic processor or processors are also capable of writing data to the electronic storage 332.

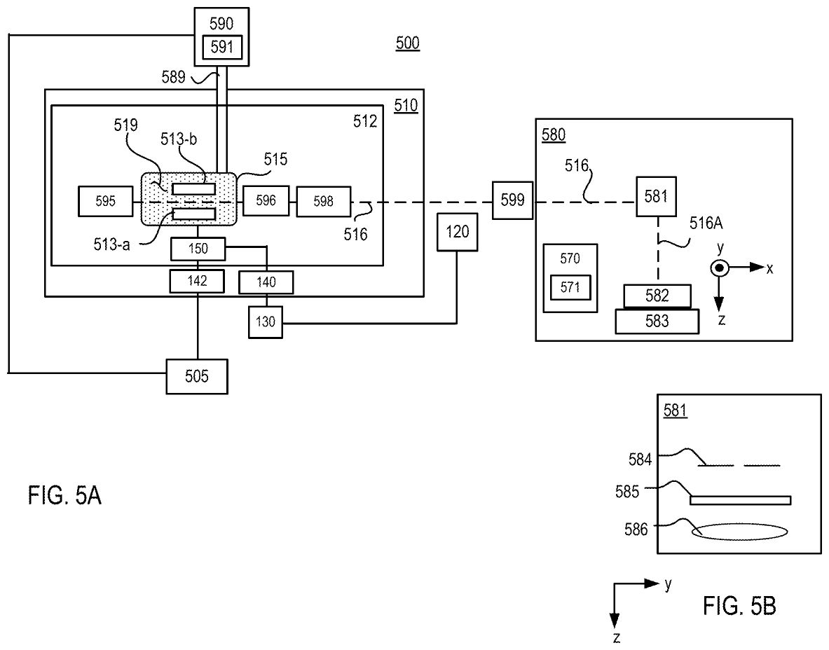

The electronic storage 332 is any type of computer-readable or machine-readable medium. For example, the electronic storage 332 may be volatile memory, such as RAM, or non-volatile memory. In some implementations, the electronic storage 332 includes non-volatile and volatile portions or components. The electronic storage 332 may store data and information that is used in the operation of the command module 330. The electronic storage 332 also may store instructions (for example, in the form of a computer program) that cause the command module 330 to interact with components and subsystems in the bias power supply 140, the switching network 150, the monitoring apparatus 120, the optical source 110, and/or a scanner apparatus (such as the scanner apparatus 580 shown in FIGS. 5 and 6).

The electronic storage 332 also stores instructions that implement a bias control module 336. The bias control module 336 receives information about the operating characteristics from the monitoring module 120 and determines the information for the command signal 357 from the look-up table 335.

The command signal 357 controls the bias power supply 140 to provide an input to the electrical network 156. The electrical network 156 generates the electrical quantity 149 from the input. The electrical quantity 149 changes the magnetization of the core 151 (FIG. 1A) to a desired operating point. In this way, the electrical quantity 149 adjusts the impedance of the magnetic switch that includes the core 151 based on the operating characteristics.

The command signal 357 includes information that determine the properties of the output voltage and/or current that the bias power supply 140 provides to the electrical network 156. For example, the bias power supply 140 may produce a DC voltage and/or a DC current, and the command signal 357 may control the magnitude and/or polarity of the DC voltage and/or DC current. In some implementations, the bias power supply 140 provides a constant voltage and/or current, and the command signal 357 controls an external element between the bias power supply 140 and the electrical network 156. For example, the command signal 357 may control a potentiometer or other element to thereby control the input to the electrical network 156.

Regardless of how the command signal 357 controls the input to the electrical network 156, the information in the command signal 357 is determined based on one or more operating characteristics. For example, the information in the command signal 357 may be determined from a look-up table or database 335. The look-up table or database 335 associates information about the electrical quantity 149 and/or the input to the electrical network 156 with one or more operating characteristics. The information about the electrical quantity 149 may include, for example, an amplitude, a polarity, and/or a temporal duration of the electrical quantity 149. For example, the look-up table 335 may associate a value of the magnitude and polarity of the electrical quantity 149 and/or an input to the electrical network 156 that would produce such an electrical quantity 149 with an operating condition of the optical source 110, the switching network 150, and/or the power source 142. The operating condition of the optical source 110 is defined by one or more operating characteristics of the optical source. For example, an operating condition may be defined by the voltage applied to the excitation mechanism 113, a wavelength of the light beam 116, a pressure of the gain medium 119, and/or a repetition rate of the light beam 116.

In another example, the look-up table 335 may associate one or more properties of the electrical quantity 149 and/or an input to the electrical network 156 with an operating condition of the switching network 150. The operating condition of the switching network 150 may be defined by a temperature of the core 151, and/or a specified voltage for the capacitor 143.

In yet another example, the look-up table 335 may associate may associate one or more properties of the electrical quantity 149 and/or an input to the electrical network 156 with an operating condition of the system 100. The operating condition of the system 100 is defined by at least one operating condition of at least two different sub-systems of the system 100. For example, an operating condition of the system 100 may be defined by a temperature of the gain medium 119 and a temperature of the core 151.

The look-up table or database 335 includes at least two operating conditions and may include tens, hundreds, thousands, or more different operating conditions, each of which is associated with one or more properties of the electrical quantity 149 and/or information about an input to be provided to the electrical network 156. The properties of the electrical quantity 149 and/or a value of an input to be provided to the electrical network 156 for a particular operating condition may be collected during manufacturing of the optical source 110, an operator (for example, an end user or maintenance personnel) may enter values into the look-up table 335 after the optical source 110 is installed, or the look-up table 335 may be updated automatically via the I/O interface 333. Moreover, other implementations are possible. For example, in some implementations, instead of or in addition to the look-up table 335, the electronic storage 332 stores instructions that implement a mathematical relationship between the electrical quantity 149 and an operating condition. The mathematical relationship may be determined from empirical data that observes the amount of impedance or magnetization of a magnetic core after the optical source 110 produces a pulse of light.

If the look-up table 335 does not include the operating condition of interest, the bias control module 336 may interpolate between the operating conditions that are most similar to the operating condition of interest. The bias control module 336 generates the command signal 357 with information that is sufficient for the bias power supply 140 and/or the electrical network to generate the bias current (or other form of the electrical quantity 149).

The monitoring module 120 is any type of device that is capable of monitoring the operating characteristics. For example, the monitoring module 120 may include optical and/or electronic components that measure operating characteristics such as repetition rate or voltage applied to the excitation mechanism 113. In some implementations, the monitoring module 120 accesses the values of the operating characteristics from the optical source 110, the switching network 150, and/or the power source 142. In these implementations, the monitoring module 120 does not directly measure the operating characteristics. For example, the monitoring module 120 may obtain readings from other sensors (such as temperature or pressure sensors) that perform direct measurements and/or may obtain set values that are set at the time of manufacture and are stored in memory in a particular subsystem of the source 110.

The monitoring module 120 may provide values of the one or more operating characteristics to the command module 330 after each pulse in the light beam 116. In still other implementations, information from the monitoring module 120 is not used and the operator of the optical source 110 enters the operating characteristics into the command module 330 directly through the I/O interface 333.

The electronic storage 332 also stores instructions that make up a laser command module 337. The laser command module 337 controls various aspects of the operation of the optical source 110 and/or the pulse-generating network 152. The laser command module 337 controls, for example, the state of the switches 148 and 145. The laser command module 337 triggers the switch 148 to close after the voltage across the capacitor 143 in the resonant charger reaches the specified voltage or after a pre-determined amount of time has passed. The laser command module 337 triggers the switch 145 to close after the voltage across the capacitor 159 reaches a specified voltage. For example, in implementations in which the switches 148 and 145 are transistors, the laser command module 337 may control a voltage source that provides a voltage to the gate of the transistors, where the voltage is sufficient to cause the transistors to change state and conduct current. The specified voltage and pre-determined time are stored on the electronic storage 332.

The laser command module 337 also may control other aspects of the optical source 110, such as the repetition rate of the light beam 116. The laser command module 337 may control the various aspects based on a pre-programmed recipe that is also stored on the electronic storage 332 and/or is provided through the I/O interface 333.

The electronic storage 332 also may store various other parameters and values used in the operation of the optical source 110 and/or the pulse-generating network 152.

The I/O interface 333 is any kind of interface that allows the command module 330 to exchange data and signals with an operator, other devices (such as the monitoring module 120), and/or an automated process running on another electronic device. For example, in implementations in which rules or instructions stored on the electronic storage 332 may be edited, the edits may be made through the I/O interface 333. The I/O interface 333 may include one or more of a visual display, a keyboard, and a communications interface, such as a parallel port, a Universal Serial Bus (USB) connection, and/or any type of network interface, such as, for example, Ethernet. The I/O interface 333 also may allow communication without physical contact through, for example, an IEEE 802.11, Bluetooth, or a near-field communication (NFC) connection.

FIG. 4 is a schematic of a switching network 450. The switching network 450 is an example of a switching network that is used with a two-stage optical system such as the optical systems shown in FIG. 2 and FIG. 6. The switching network 450 is used with the power source 142 and the command module 330. The switching network 450 includes a first commutator 470_1 and a first compression head 472_1, which produce an electrical pulse that creates a potential difference across a first set of separated electrodes 413_1. The electrodes 413_1 are enclosed in a first discharge chamber that also includes a first gaseous gain medium. The switching network 450 also includes a second commutator 470_2 and a second compression head 4722, which produce an electrical pulse that creates a potential difference across a second set of separated electrodes 413_2. The separated electrodes 413_2 are enclosed in a second discharge chamber that also encloses a gaseous gain medium.

The resonant charging circuit 135 is electrically connected to a capacitor 459_1 and to an emitter of a switch 445_1. In this example, the switch 445_1 is an insulated bi-polar gate transistor (IGBT). The gate of the switch 445_1 is coupled to a voltage source (not shown). The high-voltage power supply 142 is triggered on, and current flows to the capacitor 459_1. When the voltage across the capacitor 459_1 meets a specified voltage, the switch 445_1 is triggered to change to an on state and current flows through the switch 445_1 and an inductor 458_1 and accumulates on a capacitor 454_1. Some of the current i1 also leaks into a magnetic switch 453a_1 and the magnetization of a core 451a_1 increases until reaching a forward saturation point. The electrical energy in the capacitor 454_1 flows through the magnetic switch 453a_1, is transformed into a higher voltage by a step-up voltage transformer 473_1 and accumulates on a capacitor 474_1. A magnetic core 451b_1 enters the forward saturation region 162. The electrical energy stored in the capacitor 474_1 flows through the magnetic switch 453b_1 and accumulates on a peaking capacitor 446_1 and creates a potential difference across the first pair of electrodes 413_1. A reflected current 447_1 is created and travels back into the magnetic switches 453b_1 and 453a_1. The second commutator 470_2 and the second compression head 472_2 operate in a similar manner.

The switching network 450 also includes electrical networks 456a_1, 456a_2, 456b_1, and 456b_2 that are electrically connected to respective bias power supplies 442a_1, 442a_2, 442b_1, and 442b_2. Each of the electrical networks 456a_1, 456a_2, 456b_1, and 456b_2 includes a resistor and an inductor that are electrically connected in series with each other and are electrically connected to a respective one of the bias power supplies 442a_1, 442a_2, 442b_1, and 442b_2. Each of the electrical networks 456a_1, 456a_2, 456b_1, and 456b_2 also includes a coil that magnetically couples the electrical network to the magnetic switch 453a_1, 453a_2, 452b_1 and 435b_2.

The bias power supplies 442a_1, 442a_2, 442b_1, and 442b_2 are coupled to the command module 330. The command module 330 controls the bias power supplies 442a_1, 442a_2, 442b_1, and 442b_2 to produce respective inputs to the electrical networks 456a_1, 456a_2, 456b_1, and 456b_2 such that respective electrical quantities 449a_1, 449a_2, 449b_1, and 449b_2 are produced. Each of the electrical quantities 449a_1, 449a_2, 449b_1, and 449b_2 is a bias current that has an amplitude and polarity that results in the magnetization of the magnetic core of the respective magnetic switch 453a_1, 453a_2, 453b_1, and 453b_2 being reset to a known value. The command module 330 controls the bias power supplies 442a_1, 442a_2, 442b_1, and 442b_2 such that the respective bias current has an amplitude and polarization that brings the respective core 451a_1, 451a_2, 451b_1, and 451b_2 to the desired magnetization. Specifically, the command module 330 controls the bias power supplies 442a_1 and 442b_1 based on one or more operating characteristics of the optical source that includes the first set of electrodes 4131, the operating characteristics of the first commutator 4701, and/or the operating characteristics of the first compression head 472_1. The command module 330 controls the bias power supplies 442a_2 and 442b_2 based on one or more operating characteristics of the optical source that includes the second set of electrodes 4132, the operating characteristics of the second commutator 470_2, and/or the operating characteristics of the second compression head 472_2.

FIGS. 5A and 6 provide additional examples of systems that may use the techniques discussed above.

FIG. 5A is an example of a deep ultraviolet (DUV) optical system 500. The system 500 includes a light-generation module 510 that provides an exposure beam (or output light beam) 516 to a scanner apparatus 580. In the example of FIG. 5A, the light-generation module 510 is used with the switching network 150. A control system 505 is also coupled to the light-generation module 510 and to various components associated with the light-generation module 510.

The light-generation module 510 includes an optical oscillator 512. The optical oscillator 512 generates the output light beam 516. The optical oscillator 512 includes a discharge chamber 515, which encloses an excitation mechanism (a cathode 513-a and an anode 513-b). The discharge chamber 515 also contains a gaseous gain medium 519 (shown with light dotted shading in FIG. 5A). A potential difference between the cathode 513-a and the anode 513-b forms an electric field in the gaseous gain medium 519. The potential difference is generated by controlling the high-voltage power supply 140 to such that the switching network 150 generates a potential difference across the electrodes 513-a and 513-b. The potential difference forms an electric field, which provides energy to the gain medium 519 sufficient to cause a population inversion and to enable generation of a pulse of light via stimulated emission.

Repeated creation of such a potential difference forms a train of pulses, which are emitted as the light beam 516. The repetition rate of the pulsed light beam 516 is determined by the rate at which voltage is applied to the electrodes 513-a and 513-b. The repetition rate of the pulses may range, for example, between about 500 and 6,000 Hertz (Hz). In some implementations, the repetition rate may be greater than 6,000 Hz, and may be, for example, 12,000 Hz or greater. Each pulse emitted from the optical oscillator 512 may have a pulse energy of, for example, approximately 1 milliJoule (mJ).

Moreover, the light beam 516 may include bursts of pulses of light separated by an interval of no light. The bursts may include hundreds or thousands of pulses of light. Within the burst, the pulses of light have a repetition rate determined by the rate at which the potential difference is formed across the electrodes 513-a and 513-b. The time between bursts is determined by the application and may be, for example, a hundred or a thousand times longer than the time between two consecutive pulses in the burst.

The control system 505 receives or accesses information from the monitoring module 120 and controls the command module 130. The command module 130 controls the bias power supply 142 such that the electrical quantity 149 (for example, a bias current) resets the magnetic core 151 (FIG. 1A) in any manner suitable for the application. For example, the electrical quantity 149 may be determined and the magnetic core 151 reset before each pulse of light is produced, before some but not all pulses of light are produced, before each burst of pulses is produced, before some but not all bursts of light that are produced, based on the passage of a pre-determined amount of time, or based on input from an operator of the DUV optical system 500. In some implementations, the electrical quantity 149 is determined and the magnetic core 151 is reset on a wafer-by-wafer basis. That is, the magnetic core 151 is reset prior to exposing a wafer 582 that is exposed in the scanner apparatus 580. In these implementations, the control system 505 may be coupled to the scanner apparatus 580 and may receive a trigger each time a new wafer is loaded for exposure.

The gaseous gain medium 519 may be any gas suitable for producing a light beam at the wavelength, energy, and bandwidth required for the application. The gaseous gain medium 519 may include more than one type of gas, and the various gases are referred to as gas components. For an excimer source, the gaseous gain medium 519 may contain a noble gas (rare gas) such as, for example, argon or krypton; or a halogen, such as, for example, fluorine or chlorine. In implementations in which a halogen is the gain medium, the gain medium also includes traces of xenon apart from a buffer gas, such as helium.

The gaseous gain medium 519 may be a gain medium that emits light in the deep ultraviolet (DUV) range. DUV light may include wavelengths from, for example, about 100 nanometers (nm) to about 400 nm. Specific examples of the gaseous gain medium 519 include argon fluoride (ArF), which emits light at a wavelength of about 193 nm, krypton fluoride (KrF), which emits light at a wavelength of about 248 nm, or xenon chloride (XeCl), which emits light at a wavelength of about 351 nm.

A resonator is formed between a spectral adjustment apparatus 595 on one side of the discharge chamber 515 and an output coupler 596 on a second side of the discharge chamber 515. The spectral adjustment apparatus 595 may include a diffractive optic such as, for example, a grating and/or a prism, that finely tunes the spectral output of the discharge chamber 515. The diffractive optic may be reflective or refractive. In some implementations, the spectral adjustment apparatus 595 includes a plurality of diffractive optical elements. For example, the spectral adjustment apparatus 595 may include four prisms, some of which are configured to control a center wavelength of the light beam 516 and others of which are configured to control a spectral bandwidth of the light beam 516.

The spectral properties of the light beam 516 may be adjusted in other ways. For example, the spectral properties, such as the spectral bandwidth and center wavelength, of the light beam 516 may be adjusted by controlling a pressure and/or gas concentration of the gaseous gain medium of the chamber 515. For implementations in which the light-generation module 510 is an excimer source, the spectral properties (for example, the spectral bandwidth or the center wavelength) of the light beam 516 may be adjusted by controlling the pressure and/or concentration of, for example, fluorine, chlorine, argon, krypton, xenon, and/or helium in the chamber 515.

The pressure and/or concentration of the gaseous gain medium 519 is controllable with a gas supply system 590. The gas supply system 590 is fluidly coupled to an interior of the discharge chamber 515 via a fluid conduit 589. The fluid conduit 589 is any conduit that is capable of transporting a gas or other fluid with no or minimal loss of the fluid. For example, the fluid conduit 589 may be a pipe that is made of or coated with a material that does not react with the fluid or fluids transported in the fluid conduit 589. The gas supply system 590 includes a chamber 591 that contains and/or is configured to receive a supply of the gas or gasses used in the gain medium 519. The gas supply system 590 also includes devices (such as pumps, valves, and/or fluid switches) that enable the gas supply system 590 to remove gas from or inject gas into the discharge chamber 515. The gas supply system 590 is coupled to the control system 505.

The optical oscillator 512 also includes a spectral analysis apparatus 598. The spectral analysis apparatus 598 is a measurement system that may be used to measure or monitor the wavelength of the light beam 516. In the example shown in FIG. 5A, the spectral analysis apparatus 598 receives light from the output coupler 596.

The light-generation module 510 may include other components and systems. For example, the light-generation module 510 may include a beam preparation system 599. The beam preparation system 599 may include a pulse stretcher that stretches each pulse that interacts with the pulse stretcher in time. The beam preparation system also may include other components that are able to act upon light such as, for example, reflective and/or refractive optical elements (such as, for example, lenses and mirrors), and/or filters. In the example shown, the beam preparation system 599 is positioned in the path of the exposure beam 516. However, the beam preparation system 599 may be placed at other locations within the system 500.

The system 500 also includes the scanner apparatus 580. The scanner apparatus 580 exposes the wafer 582 with a shaped exposure beam 516A. The shaped exposure beam 516A is formed by passing the exposure beam 516 through a projection optical system 581. The scanner apparatus 580 may be a liquid immersion system or a dry system. The scanner apparatus 580 includes a projection optical system 581 through which the exposure beam 516 passes prior to reaching the wafer 582, and a sensor system or metrology system 570. The wafer 582 is held or received on a wafer holder 583. The scanner apparatus 580 also may include, for example, temperature control devices (such as air conditioning devices and/or heating devices), and/or power supplies for the various electrical components.

The metrology system 570 includes a sensor 571. The sensor 571 may be configured to measure a property of the shaped exposure beam 516A such as, for example, bandwidth, energy, pulse duration, and/or wavelength. The sensor 571 may be, for example, a camera or other device that is able to capture an image of the shaped exposure beam 516A at the wafer 582, or an energy detector that is able to capture data that describes the amount of optical energy at the wafer 582 in the x-y plane.

Referring also to FIG. 5B, the projection optical system 581 includes a slit 584, a mask 585, and a projection objective, which includes a lens system 586. The lens system 586 includes one or more optical elements. The exposure beam 516 enters the scanner apparatus 580 and impinges on the slit 584, and at least some of the output light beam 516 passes through the slit 584 to form the shaped exposure beam 516A. In the example of FIGS. 5A and 5B, the slit 584 is rectangular and shapes the exposure beam 516 into an elongated rectangular shaped light beam, which is the shaped exposure beam 516A. The mask 585 includes a pattern that determines which portions of the shaped light beam are transmitted by the mask 585 and which are blocked by the mask 585. Microelectronic features are formed on the wafer 582 by exposing a layer of radiation-sensitive photoresist material on the wafer 582 with the exposure beam 516A. The design of the pattern on the mask is determined by the specific microelectronic circuit features that are desired.

The configuration shown in FIG. 5A is an example of a configuration for a DUV system. Other implementations are possible. For example, the light-generation module 510 may include N instances of the optical oscillator 512, where N is an integer number greater than one. In these implementations, each optical oscillator 512 is configured to emit a respective light beam toward a beam combiner, which forms the exposure beam 516.

FIG. 6 shows another example configuration of a DUV system. FIG. 6 is a block diagram of a photolithography system 600 that includes a light-generation module 610 that produces a pulsed light beam 616, which is provided to the scanner apparatus 580. The control system 505 is coupled to various components of the light-generation module 610 and the scanner apparatus 580 to control various operations of the system 600. The light-generation module 610 is used with the switching network 450.

The light-generation module 610 is a two-stage laser system that includes a master oscillator (MO) 612_1 that provides the seed light beam 618 to a power amplifier (PA) 612_2. The PA 612_2 receives the seed light beam 618 from the MO 612_1 and amplifies the seed light beam 618 to generate the light beam 616 for use in the scanner apparatus 580. For example, in some implementations, the MO 612_1 may emit a pulsed seed light beam, with seed pulse energies of approximately 1 milliJoule (mJ) per pulse, and these seed pulses may be amplified by the PA 612_2 to about 6 to 15 mJ, but other energies may be used in other examples.

The MO 612_1 includes a discharge chamber 615_1 having two elongated electrodes 613a_1 and 613b_1, a gain medium 619_1 (shown with light dotted shading in FIG. 6) that is a gas mixture, and a fan (not shown) for circulating the gas mixture between the electrodes 613a_1, 613b_1. A resonator is formed between a line narrowing module 695 on one side of the discharge chamber 615_1 and an output coupler 696 on a second side of the discharge chamber 615_1.

The discharge chamber 615_1 includes a first chamber window 663_1 and a second chamber window 664_1. The first and second chamber windows 663_1 and 664_1 are on opposite sides of the discharge chamber 615_1. The first and second chamber windows 663_1 and 664_1 transmit light in the DUV range and allow DUV light to enter and exit the discharge chamber 615_1.

The line narrowing module 695 may include a diffractive optic such as a grating that finely tunes the spectral output of the discharge chamber 615_1. The light-generation module 610 also includes a line center analysis module 668 that receives an output light beam from the output coupler 696 and a beam coupling optical system 669. The line center analysis module 668 is a measurement system that may be used to measure or monitor the wavelength of the seed light beam 618. The line center analysis module 668 may be placed at other locations in the light-generation module 610, or it may be placed at the output of the light-generation module 610.

The gas mixture that is the gain medium 619_1 may be any gas suitable for producing a light beam at the wavelength and bandwidth required for the application. For an excimer source, the gas mixture may contain a noble gas (rare gas) such as, for example, argon or krypton, a halogen, such as, for example, fluorine or chlorine and traces of xenon apart from a buffer gas, such as helium. Specific examples of the gas mixture include argon fluoride (ArF), which emits light at a wavelength of about 193 nm, krypton fluoride (KrF), which emits light at a wavelength of about 248 nm, or xenon chloride (XeCl), which emits light at a wavelength of about 351 nm. Thus, the light beams 616 and 618 include wavelengths in the DUV range in this implementation. The excimer gain medium (the gas mixture) is pumped with short (for example, nanosecond) current pulses in a high-voltage electric discharge by application of a voltage to the elongated electrodes 613a_1, 613b_1.

The PA 612_2 includes a beam coupling optical system 669 that receives the seed light beam 618 from the MO 612_1 and directs the seed light beam 618 through a discharge chamber 615_2, and to a beam turning optical element 692, which modifies or changes the direction of the seed light beam 618 so that it is sent back into the discharge chamber 615_2. The beam turning optical element 692 and the beam coupling optical system 669 form a circulating and closed loop optical path in which the input into a ring amplifier intersects the output of the ring amplifier at the beam coupling optical system 669.

The discharge chamber 615_2 includes a pair of elongated electrodes 613a_2, 613b_2, a gain medium 619_2 (shown with light dotted shading in FIG. 6), and a fan (not shown) for circulating the gain medium 619_2 between the electrodes 613a_2, 613b_2. The gas mixture that forms the gain medium 619_2 may be the same as the gas mixture that forms gain medium 619_1.

The discharge chamber 615_2 includes a first chamber window 663_2 and a second chamber window 664_2. The first and second chamber windows 663_2 and 664_2 are on opposite sides of the discharge chamber 615_2. The first and second chamber windows 663_2 and 664_2 transmit light in the DUV range and allow DUV light to enter and exit the discharge chamber 615_2.

When the gain medium 619_1 or 619_2 is pumped by creating a potential difference between the electrodes 613a_1, 613b_1 or 613a_2, 613b_2, respectively, the gain medium 619_1 and/or 619_2 emits light. The repetition rate of the pulses may range between about 500 and 6,000 Hz for various applications. In some implementations, the repetition rate may be greater than 6,000 Hz, and may be, for example, 12,000 Hz or greater, but other repetition rates may be used in other implementations.

The potential difference between the electrodes 613a_1 and 613b_1 is created using the commutator 470_1 and compression head 472_1 discussed with respect to FIG. 4. The potential difference between the electrodes 613a_2 and 613b_2 is created using the commutator 470_2 and the compression head 472_2 discussed with respect to FIG. 4. The magnetization of the each of the magnetic cores 451a_1, 451a_2, 451b_1, and 451b_2 is controlled using the respective bias currents 449a_1, 449a_2, 449b_1, and 449b_2 as discussed above. Controlling the magnetization of the magnetic cores 451a_1, 451a_2, 451b_1, and 451b_2 helps to ensure that the operation of the MO 612_1 and the PA 612_2 is efficiently and properly synchronized and coordinated. For example, controlling the magnetization of the cores 451a_1, 451a_2 and the cores 451b_1, 451b_2 with a bias current that is based on the respective operating conditions of the MO chamber 612_1 and the PA chamber 612_2 helps to ensure that population inversion exists in the gain medium 619_2 when the seed light beam 618 enters the discharge chamber 615_2.

The output light beam 616 may be directed through a beam preparation system 699 prior to reaching the scanner apparatus 580. The beam preparation system 699 may include a bandwidth analysis module that measures various parameters (such as the bandwidth or the wavelength) of the beam 616. The beam preparation system 699 also may include a pulse stretcher that stretches each pulse of the output light beam 616 in time. The beam preparation system 699 also may include other components that are able to act upon the beam 616 such as, for example, reflective and/or refractive optical elements (such as, for example, lenses and mirrors), filters, and optical apertures (including automated shutters).

The DUV light-generation module 610 also includes the gas management system 690, which is in fluid communication with an interior 678 of the DUV light-generation module 610.

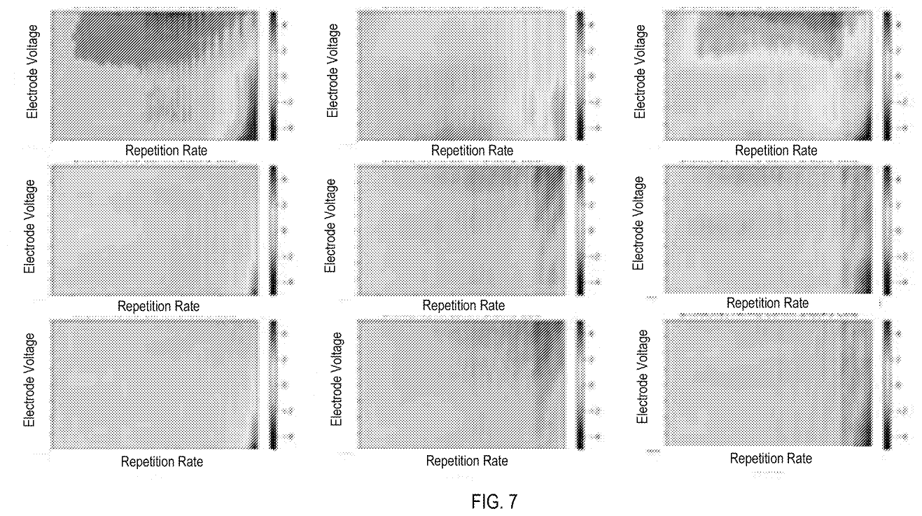

FIGS. 7-10 are examples of experimental data collected on a two-stage laser system similar to the light-generation module 610 of FIG. 6. The data plotted in FIGS. 7-10 is the delay time for a magnetic switch to reach forward saturation and produce an electrical pulse. The production of the electrical pulse corresponds with the production an optical pulse.

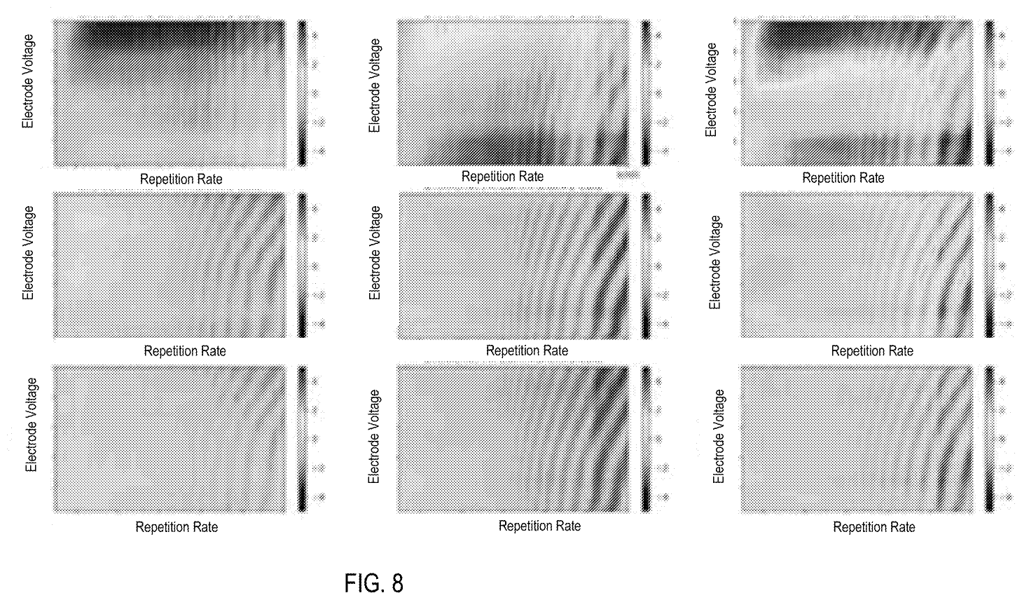

The plots in FIGS. 7-10 show delay times as a function of electrode voltage (vertical axis) and repetition rate (horizontal axis). The shading indicates the amount of observed delay time. Each of FIGS. 7-10 includes nine plots of delay time as follows: the top row of three plots is for the first pulse in a burst of pulses, the middle row of three plots is for the second pulse in the burst of pulses, and the bottom three plots is for the third pulse in the burst of pulses. In each row, the left-most plot is for the MO chamber (the discharge chamber 615_1 in FIG. 6), the middle plot is for the PA chamber (the discharge chamber 615_2 in FIG. 6), and the right-most plot is the difference between the MO delay time and the PA delay time. FIG. 7 was obtained from a MO and PA chamber operating with the gain medium at a pressure of 230 kilopascals (kPa) and a standard bias current provided to the magnetic cores of the magnetic switches. A standard bias current is a bias current that is pre-set and constant. The standard bias current is in contrast to the electrical quantity (such as the quantity discussed above 149), which may change during operation of the light source. FIG. 8 was obtained from the MO and PA chamber operating with the gain mediums at a pressure of 230 kPa and a pre-set over-bias. The constant over-bias was a larger bias current than the standard bias current. Thus, by comparing the data in FIG. 7 and FIG. 8, the effect of changing the bias current during operation is seen.

Based on the data in FIGS. 7 and 8, it is apparent that the delay difference is generally more significant for the first pulse in the burst, and the delay difference is affected by the amount of bias current. Thus, the controllable electrical quantity 149 discussed above may be used to reduce the effects of the burst transient.

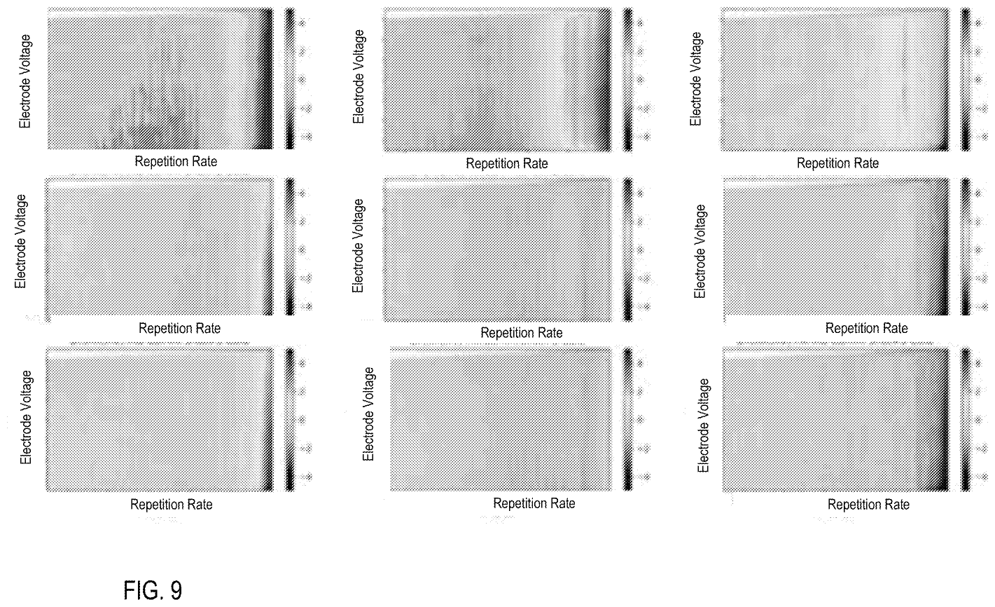

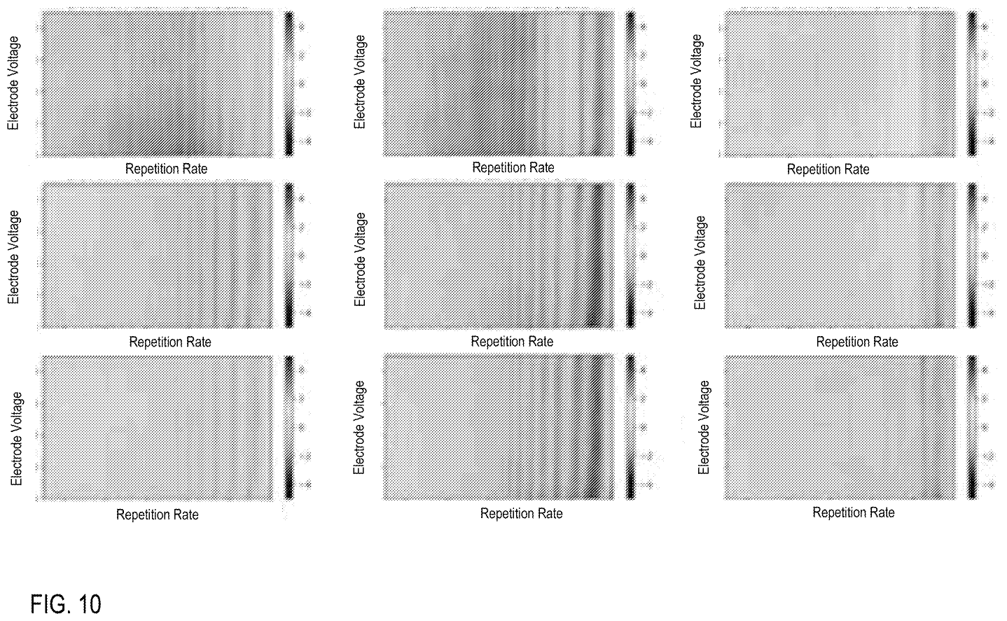

The data in FIG. 9 was obtained with the MO and PA chambers at 320 kPa and a standard bias current. The data in FIG. 10 was obtained with the MO and PA chambers at 320 kPa and a pre-set over-bias. By comparing the data in FIGS. 9 and 10, the delay difference tends to be largest for the first pulse in the burst and the difference in bias current results in different delay times. Further, comparing FIG. 9 to FIG. 7 and comparing FIG. 10 to FIG. 8 also shows that pressure impacts the delay time.

Accordingly, the controllable and adjustable electrical quantity 149 (for example), which is based on the operating characteristics of the optical source and is used to control the impedance of a magnetic switch as discussed above, improves the performance of a two-stage laser system by reducing the effects of the burst transient and improving the synchronization of the excitation of the gain mediums in the different stages.

The various embodiments can be further described using the following clauses:

1. A system comprising:
a first optical subsystem configured to produce a pulsed seed light beam, the first optical subsystem comprising:
a first chamber configured to hold a first gaseous gain medium; and
a first excitation mechanism in the first chamber;
a second optical subsystem configured to produce a pulsed output light beam based on the pulsed seed light beam, the second optical subsystem comprising:
a second chamber configured to hold a second gaseous gain medium; and
a second excitation mechanism in the second chamber;
a first magnetic switching network configured to activate the first excitation mechanism, wherein activating the first excitation mechanism causes the first optical subsystem to produce a pulse of the pulsed seed light beam;
a second magnetic switching network configured to activate the second excitation mechanism, wherein activating the second excitation mechanism causes the second optical subsystem to produce a pulse of the pulsed output light beam; and
a controller configured to:
adjust an impedance of one or more magnetic cores in the first magnetic switching network based on a first indication, wherein the first indication comprises an indication of one or more operating characteristics of one or more of the first optical subsystem and the first magnetic switching network; and
adjust an impedance of one or more magnetic cores in the second magnetic switching network based on a second indication, wherein the second indication comprises an indication of one or more operating characteristics of one or more of the second optical subsystem and the second magnetic switching network.
   2. The system of clause 1, wherein
the controller is configured to adjust the impedance of the one or more magnetic cores in the first magnetic switching network before activating the first excitation mechanism; and
the controller is configured to adjust the impedance of the one or more saturated magnetic cores of the second magnetic switching network before activating the second excitation mechanism.
   3. The system of clause 1, wherein
the first magnetic switching network comprises:
a first commutator module comprising: a first saturable reactor and a first magnetic core, and
a first compression module comprising: a second saturable reactor and a second magnetic core;
the second magnetic switching network comprises:
a second commutator module comprising: a third saturable reactor and a third magnetic core, and
a second compression module comprising: a fourth saturable reactor and a fourth magnetic core; and the controller is configured to:
adjust the impedance of the first magnetic core and the second magnetic core based on the first indication of one or more operating characteristics, and
adjust the impedance of the third magnetic core and the fourth magnetic core based on the second indication of one or more operating characteristics.
   4. The system of clause 1, wherein
the controller is configured to adjust the impedance of the one or more magnetic cores of the first magnetic switching network by providing electrical current to one or more coils, wherein each of the one or more coils is magnetically coupled to one of the one or more magnetic cores of the first magnetic switching network, and one or more properties of the electrical current is based on the first indication; and
the controller is configured to adjust the impedance of the one or more magnetic cores of the second magnetic switching network by providing electrical current to one or more coils, wherein each of the one or more coils is magnetically coupled to one of the one or more magnetic cores of the second magnetic switching network, and one or more properties of the electrical current is based on the second indication.
   5. The system of clause 4, wherein the one or more properties of the electrical current comprises an amplitude of the electrical current.
   6. The system of clause 1, wherein
the first optical chamber comprises a pressurized gain medium and the first excitation mechanism comprises two electrodes; the operating characteristics of the first optical chamber comprises one or more of: a magnitude of a voltage pulse applied to at least one of the electrodes in the first optical chamber; a repetition rate of a pulsed light beam produced by the first optical chamber; and a pressure of the gain medium in the first optical chamber; and the operating characteristics of the first magnetic switching network comprise a temperature of one or more of the magnetic cores in the first magnetic switching network; and
the second optical chamber comprises a pressurized gain medium and the second excitation mechanism comprises two electrodes; the operating characteristics of the second optical chamber comprises one or more of: a magnitude of a voltage pulse applied to at least one of the electrodes in the second optical chamber; a repetition rate of a pulsed light beam produced by the second optical chamber; and a pressure of the gain medium in the second optical chamber; and the operating characteristics of the second magnetic switching network comprise a temperature of one or more of the magnetic cores of the first magnetic switching network.
   7. The system of clause 1, wherein the first optical subsystem comprises a master oscillator, and the second optical subsystem comprises a power amplifier.
   8. The system of clause 1, wherein the pulsed seed light beam and the pulsed output light beam both comprise one or more wavelengths in the deep ultraviolet (DUV) range.
   9. The system of clause 8, wherein the first gaseous gain medium comprises argon fluoride (ArF), krypton fluoride (KrF), or xenon chloride (XeCl); and the second gaseous gain medium comprises argon fluoride (ArF), krypton fluoride (KrF), or xenon chloride (XeCl).
   10. The system of clause 1, further comprising:
a first monitoring module configured to measure the one or more operating characteristics of the first optical source and to provide the indication of the one or more operating characteristics of the first optical system to the controller; and
a second monitoring module configured to measure the one or more operating characteristics of the second optical source and to provide the indication of the one or more operating characteristics of the second optical system to the controller.
   11. A control system comprising:
a monitoring module configured to access one or more operating characteristics of an optical system, the optical system comprising an optical source and a magnetic switching network; and
a command module, the command module configured to:
control a power supply to provide an electrical quantity to an electrical network that is magnetically coupled to the magnetic switching network,
wherein the magnetic switching network is configured to provide an excitation pulse to the optical source,
the electrical quantity places a magnetic core of the magnetic switching network in a non-saturation or reverse saturation state, and
one or more properties of the electrical quantity are based on the one or more operating characteristics of the optical system.
   12. The control system of clause 11, wherein
the one or more operating characteristics of the optical system comprise any of: a magnitude of an excitation voltage provided to the optical source, a repetition rate of the pulsed light beam produced by the optical source, a temperature of the magnetic core, and a pressure of a gaseous gain medium in the optical source; and
the one or more properties of the electrical quantity comprise an amplitude and a temporal duration.
   13. The control system of clause 11, wherein the electrical quantity comprises a voltage or a current.
   14. The control system of clause 13, wherein the electrical quantity comprises a direct current (DC) electrical current, and the amplitude of the DC electrical current is based on the one or more operating characteristics of the optical system.
   15. The control system of clause 13, wherein the command module is further configured to determine a command signal based on the one or more operating characteristics of the optical system, and to control the power supply based on the command signal.
   16. The control system of clause 15, wherein the one or more properties of the electrical quantity comprise an amplitude and a temporal duration, the amplitude has a value that depends on one or more of the operating characteristics, and the temporal duration has a value that depends on one or more of the operating characteristics.
   17. The control system of clause 11, wherein the controller controls the power supply after each pulse of a plurality of pulses in the pulsed light beam produced by the optical system such that the magnetic core of the magnetic switch is placed in the non-saturation or reverse saturation state after each of the plurality of pulses is produced.
   18. The control system of clause 17, wherein the plurality of pulses are consecutive pulses in a burst of pulses.
   19. The control system of clause 17, wherein the plurality of pulses comprises a first pulse in a first burst of pulses and a second pulse in a second burst of pulses.
   20. The control system of clause 17, wherein one property of the electrical quantity has a first value to place the magnetic core in the non-saturation or reverse saturation state after a first one of the plurality of pulses and a second value to place the magnetic core in the non-saturation or reverse saturation state after a second one of the plurality of pulses, and the first value is different than the second value.
   21. A method comprising:
determining one or properties of an electrical quantity based on one or more operating characteristics of an optical system that comprises a laser system;
adjusting an impedance of a magnetic core of a magnetic switching network by providing the electrical quantity to a coil that is magnetically coupled to the magnetic core; and
after adjusting the impedance of the magnetic core, producing a pulse of light, wherein producing the pulse of light comprises: saturating the magnetic core such that an electrical pulse is provided to an excitation mechanism of the laser system.
   22. The method of clause 21, wherein the electrical quantity comprises an electrical current, and the one or more properties of the electrical quantity comprise a magnitude or a temporal duration.
   23. The method of clause 21, wherein the one or more operating characteristics comprise one or more of a magnitude of an excitation voltage provided to the laser system, a repetition rate of a pulsed light beam produced by the laser system, a temperature of the magnetic core, and a pressure of a gaseous gain medium of the laser system.
   24. The method of clause 21, wherein adjusting the impedance of the magnetic core comprises adjusting the impedance of the magnetic core to a pre-determined level.
   25. The method of clause 21, wherein adjusting the impedance of the magnetic core comprises placing the magnetic core in a reverse saturation state.

The preceding and other implementations are within the scope of the following claims.

1. A system comprising:
a first optical subsystem configured to produce a pulsed seed light beam, the first optical subsystem comprising:
a first chamber configured to hold a first gaseous gain medium; and
a first excitation mechanism in the first chamber;
a second optical subsystem configured to produce a pulsed output light beam based on the pulsed seed light beam, the second optical subsystem comprising:
a second chamber configured to hold a second gaseous gain medium; and
a second excitation mechanism in the second chamber;
a first magnetic switching network configured to activate the first excitation mechanism, wherein activating the first excitation mechanism causes the first optical subsystem to produce a pulse of the pulsed seed light beam;
a second magnetic switching network configured to activate the second excitation mechanism, wherein activating the second excitation mechanism causes the second optical subsystem to produce a pulse of the pulsed output light beam; and
a controller configured to:
adjust an impedance of one or more magnetic cores in the first magnetic switching network based on a first indication, wherein the first indication comprises an indication of one or more operating characteristics of one or more of the first optical subsystem and the first magnetic switching network; and
adjust an impedance of one or more magnetic cores in the second magnetic switching network based on a second indication, wherein the second indication comprises an indication of one or more operating characteristics of one or more of the second optical subsystem and the second magnetic switching network.

2. The system of claim 1, wherein
the controller is configured to adjust the impedance of the one or more magnetic cores in the first magnetic switching network before activating the first excitation mechanism; and
the controller is configured to adjust the impedance of the one or more saturated magnetic cores of the second magnetic switching network before activating the second excitation mechanism.

3. The system of claim 1, wherein
the first magnetic switching network comprises:
a first commutator module comprising: a first saturable reactor and a first magnetic core, and
a first compression module comprising: a second saturable reactor and a second magnetic core;
the second magnetic switching network comprises:
a second commutator module comprising: a third saturable reactor and a third magnetic core, and
a second compression module comprising: a fourth saturable reactor and a fourth magnetic core; and
the controller is configured to:
adjust the impedance of the first magnetic core and the second magnetic core based on the first indication of one or more operating characteristics, and
adjust the impedance of the third magnetic core and the fourth magnetic core based on the second indication of one or more operating characteristics.

4. The system of claim 1, wherein
the controller is configured to adjust the impedance of the one or more magnetic cores of the first magnetic switching network by providing electrical current to one or more coils, wherein each of the one or more coils is magnetically coupled to one of the one or more magnetic cores of the first magnetic switching network, and one or more properties of the electrical current is based on the first indication; and
the controller is configured to adjust the impedance of the one or more magnetic cores of the second magnetic switching network by providing electrical current to one or more coils, wherein each of the one or more coils is magnetically coupled to one of the one or more magnetic cores of the second magnetic switching network, and one or more properties of the electrical current is based on the second indication.

5. The system of claim 4, wherein the one or more properties of the electrical current comprises an amplitude of the electrical current.

6. The system of claim 1, wherein
the first optical chamber comprises a pressurized gain medium and the first excitation mechanism comprises two electrodes; the operating characteristics of the first optical chamber comprises one or more of: a magnitude of a voltage pulse applied to at least one of the electrodes in the first optical chamber; a repetition rate of a pulsed light beam produced by the first optical chamber; and a pressure of the gain medium in the first optical chamber; and the operating characteristics of the first magnetic switching network comprise a temperature of one or more of the magnetic cores in the first magnetic switching network; and
the second optical chamber comprises a pressurized gain medium and the second excitation mechanism comprises two electrodes; the operating characteristics of the second optical chamber comprises one or more of: a magnitude of a voltage pulse applied to at least one of the electrodes in the second optical chamber; a repetition rate of a pulsed light beam produced by the second optical chamber; and a pressure of the gain medium in the second optical chamber; and the operating characteristics of the second magnetic switching network comprise a temperature of one or more of the magnetic cores of the first magnetic switching network.

7. The system of claim 1, wherein the first optical subsystem comprises a master oscillator, and the second optical subsystem comprises a power amplifier.

8. The system of claim 1, wherein the pulsed seed light beam and the pulsed output light beam both comprise one or more wavelengths in the deep ultraviolet (DUV) range.

9. The system of claim 8, wherein the first gaseous gain medium comprises argon fluoride (ArF), krypton fluoride (KrF), or xenon chloride (XeCl); and the second gaseous gain medium comprises argon fluoride (ArF), krypton fluoride (KrF), or xenon chloride (XeCl).

10. The system of claim 1, further comprising:
a first monitoring module configured to measure the one or more operating characteristics of the first optical source and to provide the indication of the one or more operating characteristics of the first optical system to the controller; and
a second monitoring module configured to measure the one or more operating characteristics of the second optical source and to provide the indication of the one or more operating characteristics of the second optical system to the controller.

11. A control system comprising:
a monitoring module configured to access one or more operating characteristics of an optical system, the optical system comprising an optical source and a magnetic switching network; and
a command module, the command module configured to:
control a power supply to provide an electrical quantity to an electrical network that is magnetically coupled to the magnetic switching network,
wherein the magnetic switching network is configured to provide an excitation pulse to the optical source,
the electrical quantity places a magnetic core of the magnetic switching network in a non-saturation or reverse saturation state, and
one or more properties of the electrical quantity are based on the one or more operating characteristics of the optical system.

12. The control system of claim 11, wherein
the one or more operating characteristics of the optical system comprise any of: a magnitude of an excitation voltage provided to the optical source, a repetition rate of the pulsed light beam produced by the optical source, a temperature of the magnetic core, and a pressure of a gaseous gain medium in the optical source; and
the one or more properties of the electrical quantity comprise an amplitude and a temporal duration.

13. The control system of claim 11, wherein the electrical quantity comprises a voltage or a current.

14. The control system of claim 13, wherein the electrical quantity comprises a direct current (DC) electrical current, and the amplitude of the DC electrical current is based on the one or more operating characteristics of the optical system.

15. The control system of claim 13, wherein the command module is further configured to determine a command signal based on the one or more operating characteristics of the optical system, and to control the power supply based on the command signal.

16. The control system of claim 15, wherein the one or more properties of the electrical quantity comprise an amplitude and a temporal duration, the amplitude has a value that depends on one or more of the operating characteristics, and the temporal duration has a value that depends on one or more of the operating characteristics.

17. The control system of claim 11, wherein the controller controls the power supply after each pulse of a plurality of pulses in the pulsed light beam produced by the optical system such that the magnetic core of the magnetic switch is placed in the non-saturation or reverse saturation state after each of the plurality of pulses is produced.

18. The control system of claim 17, wherein the plurality of pulses are consecutive pulses in a burst of pulses.

19. The control system of claim 17, wherein the plurality of pulses comprises a first pulse in a first burst of pulses and a second pulse in a second burst of pulses.

20. The control system of claim 17, wherein one property of the electrical quantity has a first value to place the magnetic core in the non-saturation or reverse saturation state after a first one of the plurality of pulses and a second value to place the magnetic core in the non-saturation or reverse saturation state after a second one of the plurality of pulses, and the first value is different than the second value.

21. A method comprising:
determining one or properties of an electrical quantity based on one or more operating characteristics of an optical system that comprises a laser system;
adjusting an impedance of a magnetic core of a magnetic switching network by providing the electrical quantity to a coil that is magnetically coupled to the magnetic core; and
after adjusting the impedance of the magnetic core, producing a pulse of light, wherein producing the pulse of light comprises: saturating the magnetic core such that an electrical pulse is provided to an excitation mechanism of the laser system.

22. The method of claim 21, wherein the electrical quantity comprises an electrical current, and the one or more properties of the electrical quantity comprise a magnitude or a temporal duration.

23. The method of claim 21, wherein the one or more operating characteristics comprise one or more of a magnitude of an excitation voltage provided to the laser system, a repetition rate of a pulsed light beam produced by the laser system, a temperature of the magnetic core, and a pressure of a gaseous gain medium of the laser system.

24. The method of claim 21, wherein adjusting the impedance of the magnetic core comprises adjusting the impedance of the magnetic core to a pre-determined level.

25. The method of claim 21, wherein adjusting the impedance of the magnetic core comprises placing the magnetic core in a reverse saturation state.
